(19) United States
(12) Patent Application Publication
(10) Pub. No.: US 2005/0062405 A1
(43) Pub. Date: Mar. 24, 2005

(54) Organic light-emitting device

(76) Inventor: Kuan-Chang Peng, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/790,818

(22) Filed: Mar. 3, 2004

(30) Foreign Application Priority Data
Sep. 23, 2003 (TW) 092126255

(51) Int. Cl. H05B 33/14; H05B 33/00

(52) U.S. Cl. 313/504; 313/506; 313/503

(57) ABSTRACT

A light-emitting device is provided. The device is with increased current efficiency, having a plurality of emitter presented between an anode and a cathode. Each of the emitters may be allowed for projecting a corresponding color light source and stacked in turn between the cathode and anode. When a supplied voltage is initialized to operate, the color light sources generated by the respective emitters may be added, such that the current density passing through the element may be reduced without degrading the whole brightness, resulting in not only a better current efficiency, bit also a reduced working temperature as well as a prolonged service life of the element.

### FIELD OF THE INVENTION

The present invention is related to a light-emitting device, particularly to an organic light-emitting device with increased current efficiency, allowed for not only achieving a better current efficiency, but also reducing the working temperature and prolonging the service life of the element.

### BACKGROUND

Organic light-emitting diodes (OLEDs) have been regarded as the super production in the display industry due to the merits of self-brightness, high response speed, low weight, thin thickness, low power consumption, large view angle, high brightness, full-color fashion, simple fabrication thereof, since implementable OLED elements with heterostructure were formed from Alq₃ and HTM2 via vacuum evaporation by C. W. Tang and S. A. VanSlyke, Kodak, in 1987.

Referring to FIG. 1, there is shown a structural cross section view of a conventional OLED. An organic light-emitting diode (OLED) 10 may be mainly formed with a transparent electro-conductive anode (Indium Tin Oxide, ITO) 13 onto a transparent substrate 11 by vaporation, and then formed with a hole transport layer (HTL) 15, an emitting layer (EML) 17, and a metal cathode 19 on the ITO anode 13 in turn, in which a fluorescent substance D may be doped inside the emitting layer 17. When a biasing effect applied by a supplied voltage 18 is presented between the anode 13 and the cathode 19, holes may be transported to the emitting layer 17 from the ITO anode 13 through the hole transport layer 15, while electrons may be also transported to the emitting layer 17 from the cathode 17, correspondingly. Then, it is followed by the recombination of the electrons and the holes in the emitting layer 17, which may generate excitons. The excitons themselves may emit light within the emitting layer 17 if they return back to the ground state in company with releasing energy, or if the doped fluorescent substance D is further excited to the excited state, and may generate a colorful light source with a predetermined specified range of wavelength.

The above conventional OLED structure is sufficient for the projection of the light source; however, there are still many articles to be improved. For instance, “How to enhance the current efficiency (luminous yield; cd/A) of the whole OLED structure?”, “How to reduce the working temperature?”, “How to prolong the service life of the element?”, or, “How to generate the white light source?”, and so on. All of these objects are researched and developed with an effort by the industry for a long time.

### SUMMARY OF THE INVENTION

For this reason, how to design a novel organic light-emitting device with not only an enhanced current efficiency, but also a reduced working temperature of the element, a prolonged service life of the element, as well as the ability for generating a white light source, is the key point of the present invention.

It is a primary object to provide an organic light-emitting device used with a plurality of stacked emitters for obtaining an additive effect of individual colorful light sources so as to achieve a better current efficiency without degrading the whole projection light source.

It is a secondary object of the present invention is to provide an organic light-emitting device having a reduced working temperature and thus a prolonged service life of elements owing to an effective control for the current density in each of the elements.

It is another object of the present invention is to provide an organic light-emitting device allowed for generating a white light source with the stack of a plurality of emitters, capable of generating different colorful light sources.

It is still another object of the present invention to provide an organic light-emitting device used with a plurality of emitters to be stacked together for the effective enhancement of the luminance (brightness) as a whole.

Therefore, for achieving aforementioned objects, the primary structure according to one preferred embodiment of the present invention comprises: a first electro-conductive layer; a plurality of emitters, wherein a first emitter is provided on the top surface of the first electro-conductive layer, and the other emitters are provided on the top surface of the first emitter in turn, until the last N-th emitter; and a second electro-conductive layer, provided on the top surface of a N-th emitter, wherein a supplied voltage is connectedly provided between the first and the second electro-conductive layers.

### BRIEF DESCRIPTION OF DRAWINGS

FIG. 1 is a structural cross section view of a conventional organic light-emitting device;

FIG. 2 is a structural cross section view of an organic light-emitting device according to one preferred embodiment of the present invention;

FIG. 3 is a diagram for comparing the brightness-current efficiency relation of the OLED of the present invention with that of the conventional structure in an experiment set;

FIG. 4 is a structural cross section view of the OLED according to another embodiment of the present invention; and

FIG. 5 is a structural cross section view of the OLED according to still another embodiment of the present invention.

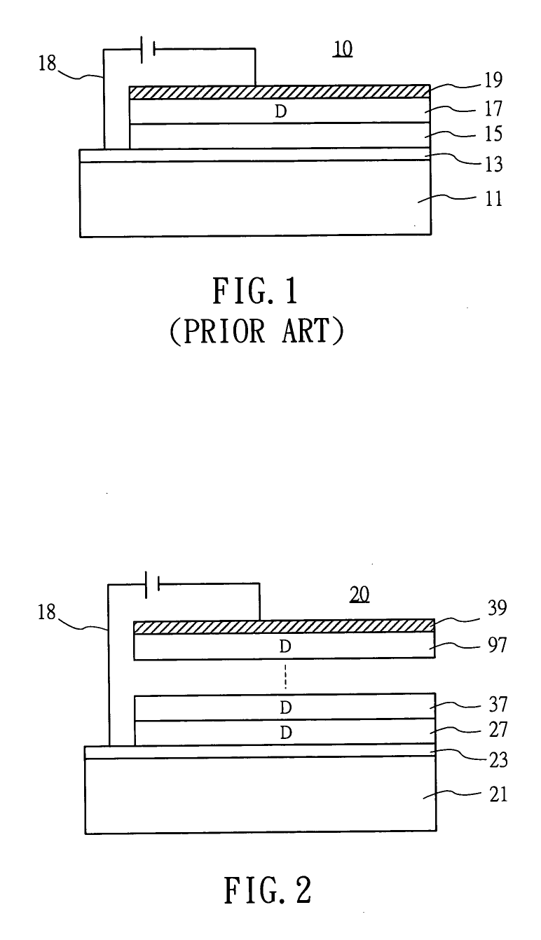

### DETAILED DESCRIPTION

The structural features and the effects to be achieved may further be understood and appreciated by reference to the presently preferred embodiments together with the detailed description.

Firstly, referring to FIG. 2, there is shown a structural cross section view according to one preferred embodiment of the present invention. An organic light-emitting device 20 of the present invention mainly comprises a transparent substrate 21 formed, by means of evaporation or sputtering, with a first electro-conductive layer 23 (for example, anode made from indium tin oxide (ITO) thereon, and then formed with a first emitter 27 (1^{st} emitter) used for generating a first colorful light source on the top surface of the anode 23, a second emitter 37 used for generating a second colorful light source on the top surface of the first emitter 27, and so on, until a last N-th emitter 97 used for generating a N-th colorful light source, in order to form a plurality of stacked emitters. Furthermore, a second electro-conductive layer 29 (for example, cathode made from metals such as Al, Mg, Li) is further provided on the top surface of the N-th emitter 97, and a supplied voltage 28 is connectedly provided between the first electro-conductive layer 23 and the second electro-conductive layer 29.

The individual colorful light sources generated by the plurality of emitters 27, 37, 97 may be added, due to the fact that these emitters are formed between the anode 23 and the cathode 29 in turn in the stacked manner. When the supplied voltage 28 operates, the working voltage (V) across each of the emitters 27, 37, 97 may be fundamentally the same. As such, the brightness of the light source projected from the emitters 27, 37, and 97 as a whole may be relatively increased if the individual light sources generated by each of these emitters are presented as the same colorful light. On the contrary, a white light source may be obtained by the cooperation and light-mixing effect if the individual light sources generated by each of the emitters 27, 37, 97 may be a red light source, a blue light source, and a green light source, respectively.

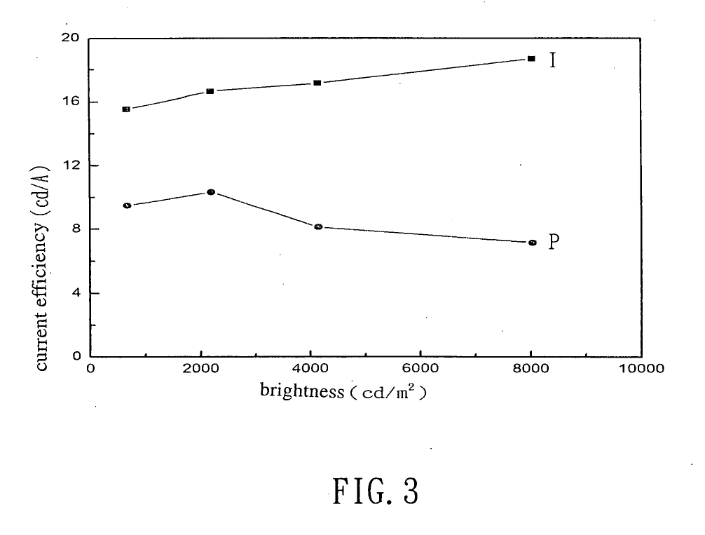

Moreover, referring to FIG. 3, there is shown a diagram for comparing the brightness-current efficiency relation of the OLED of the present invention with that of the conventional structure in an experiment set. As shown in this figure, for the OLED structure of a conventional single-layered emitter (as illustrated by a curve P), the measured brightness is 4150 cd/m² and the current efficiency is 8.11 cd/A, while the converted current density is 51.2 mA/cm², in the case of the supplied working voltage of 5V. For different working voltages, different brightness and corresponding current efficiency may be obtained. The experimental results are listed as follows:

| working voltage (V) | 4 | 4.5 | 5 | 5.5 |
|---|---|---|---|---|
| brightness (cd/m²) | 671 | 2197 | 4150 | 8036 |
| current efficiency | 9.5 | 10.33 | 8.11 | 7.14 |
| (cd/A) | | | | |

On the contrary, the OLED structure of double-layered emitters (27, 37) (as illustrated by a curve I), the supplied working voltage of 10.5V is needed when the equivalent resultant brightness of 4150 cd/m² is desirable. In this case, the measured current efficiency is 17.13 cd/A, while the converted current density is 24.2 mA/cm². Again, for different working voltages, different brightness and corresponding current efficiency may be obtained. The experimental results are listed as follows:

| working voltage (V) | 9.5 | 10 | 10.5 | 11 |
|---|---|---|---|---|
| brightness (cd/m²) | 702 | 2045 | 4150 | 8036 |
| current efficiency | 15.54 | 16.54 | 17.13 | 18.68 |
| (cd/A) | | | | |

It is apparent from above two tables and FIG. 3, the current efficiency of the stacked OLED structure (P) with doubled-layered emitters of the present invention is evidently higher than that of the conventional OLED structure (1) with single-layered emitter, if the brightness of both of them are equal. This may facilitate the commercialization of the OLED structure. Moreover, the current density flowing through the element is effectively reduced owing to the stacked formation between the cathode and the anode in the present invention, although the value of working voltage used in the present invention is relatively raised. Thus, the high working temperature may be obviated, and the service life of the element may be effectively prolonged, correspondingly.

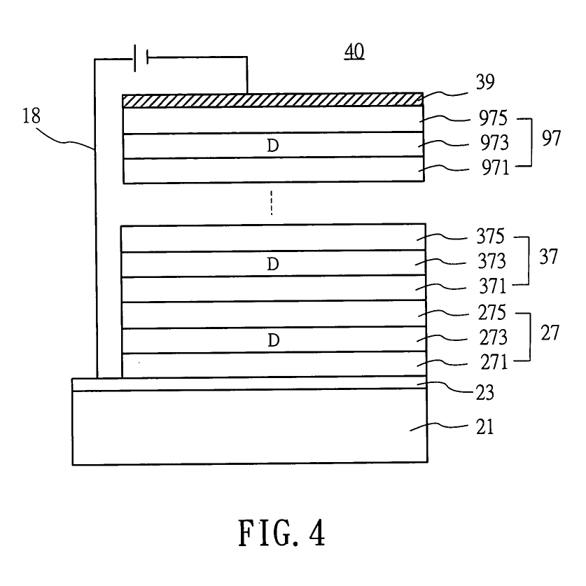

Furthermore, referring to FIG. 4, there is shown a structural cross section view according to another embodiment of the present invention. Differently from the above embodiment, in which one emitter is composed of only one emitter layer, the emitter 27 of a light-emitting device 40 in this embodiment further comprises a hole transport layer (HTL) 271 and an electron transport layer (ETL) 275 in addition to an emitting layer (EMT) 273, as shown in this figure. Again, the plurality of emitters 27, 37, 97 are stacked in turn between the anode 23 and the cathode 29, each emitter 27 (37, 97) composed of a hole transport layer (HTL) 271 (371, 971), emitting layer (EMT) 273 (373, 973), and an electron transport layer (ETL) 275 (375. 975). Thereby, the better current efficiency, and service life of the element may be equally obtained.

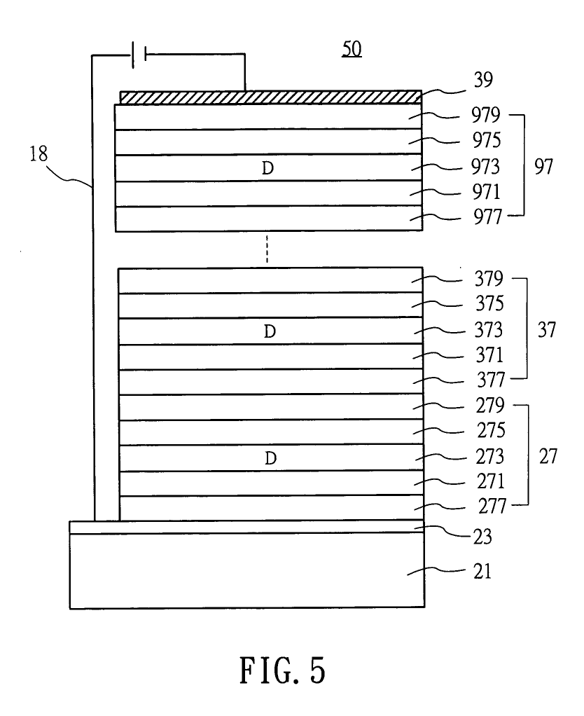

Finally, referring to FIG. 5, there is shown a structural cross section view according to still another embodiment of the present invention. In this embodiment, as shown in this figure, each emitter 27 (37, 97) of a light-emitting device 50 is composed of an electron-injecting layer (HIL) 277 (377, 977), the hole transport layer 271 (371, 971), the emitting layer (EMT) 273 (373, 973), the electron transport layer (ETL) 275 (375, 975), and an electron injecting layer (EIL) 279 (379, 979). Again, the emitters may be stacked between the anode 23 and the cathode 29 in turn, such that the current density and the working temperature may be reduced to correspondingly achieve the better current efficiency and service life under the same brightness requirement, owing to the additive effect provided by these emitters.

Furthermore, in the aforementioned embodiments, each of the emitters (27, 37, 97) may be doped with at least one dopant D. The dopant D is selected from a fluorescent substance or a phosphorescent substance in order to acquire a better luminous effect.

To sum up, it should be understood that the present invention is related to a light-emitting device, particularly to an organic light-emitting device with increased current efficiency, allowed for not only achieving a better current efficiency, but also reducing the working temperature and prolonging the service life of the element as well as generating a white light source.

The foregoing description is merely one embodiment of present invention and not considered as restrictive. All equivalent variations and modifications in process, method, feature, and spirit in accordance with the appended claims may be made without in any way from the scope of the invention.

### LIST OF REFERENCE SYMBOLS

10 light-emitting device
11 transparent substrate
13 anode
15 hole transport layer
17 emitting layer
18 supplied voltage
19 cathode
20 light-emitting device
21 transparent substrate
23 anode
27 first emitter
271 hole transport layer
273 emitting layer
275 hole transport layer
277 hole-injecting layer
279 electron-injecting layer
28 supplied voltage
29 cathode
37 second emitter
371 hole transport layer
373 emitting layer
375 hole transport layer
377 hole-injecting layer
379 electron-injecting layer
40 light-emitting device
50 light-emitting device
97 N-th emitter
971 hole transport layer
973 emitting layer
975 hole transport layer
977 hole-injecting layer
979 electron-injecting layer

1. An organic light-emitting device, comprising:
a first electro-conductive layer;
a plurality of emitters, wherein a first emitter is provided on the top surface of said first electro-conductive layer, and the other emitters are stacked up the top surface of said first emitter in turn, until a last N-th emitter; and
a second electro-conductive layer, provided on the top surface of said N-th emitter, a supplied voltage connectedly provided between said first and said second electro-conductive layers.

2. The organic light-emitting device according to claim 1, wherein said emitters are emitting layers.

3. The organic light-emitting device according to claim 2, wherein said emitters are further selected from the group consisting of a hole-injecting layer, hole transport layer, electron transport layer, electron-injecting layer, and the combination thereof.

4. The organic light-emitting device according to claim 1, wherein each of said emitters is allowed for projecting a colorful light source.

5. The organic light-emitting device according to claim 4, wherein said colorful light sources projected by each of said emitters are presented as the same color.

6. The organic light-emitting device according to claim 4, wherein said colorful light sources projected by each of said emitters are individually presented as a color selected from the group consisting of red, blue, green, and the combination thereof.

7. The organic light-emitting device according to claim 1, further comprising a transparent substrate provided at the bottom surface of said first electro-conductive layer.

8. The organic light-emitting device according to claim 1, wherein each of said emitters further comprising at lest one dopant optionally provided therein.

9. The organic light-emitting device according to claim 8, wherein said dopant is selected from the group consisting of a fluorescent substance, phosphorescent substance, and the combination thereof.
